(19) United States
(12) Patent Application Publication
(10) Pub. No.: US 2002/0097968 A1
(43) Pub. Date: Jul. 25, 2002

(54) Dispersion compensating module

(76) Inventor: Masahito Morimoto, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/965,660

(22) Filed: Sep. 25, 2001

(30) Foreign Application Priority Data
Sep. 29, 2000 (JP) 2000-298967

(51) Int. Cl. G02B 6/26; G02F 1/35

(52) U.S. Cl. 385/122; 385/39; 359/330

(57) ABSTRACT

A dispersion compensating module which can compensate the chromatic dispersion of an optical transmission line and which suppresses wavelength distortions ascribable to nonlinear phenomena, is provided. Signal light inputted from a light input portion (19 in FIG. 1) is caused to enter the nonlinear medium (3) of phase conjugate wave generation means (15) by passing it through a light input waveguide (2), a beam splitter (22) and a light input/output waveguide (18) in succession. The nonlinear medium (3) is pumped by pumping light emitted from a pump LD (4), thereby to generate a phase conjugate wave. The generated phase conjugate wave is passed through the light input/output waveguide (18), is reflected by the beam splitter (22) and is passed through a light output waveguide (6) so as to be outputted from a light output portion (20). The light input waveguide (2) is provided with a first isolator (7) which restrains any light from retroceding onto the input side of the signal light. Besides, the light output waveguide (6) is provided with a second isolator (8) which restrains any light from retroceding onto the side of the phase conjugate wave generation means (15). Preferably, the dispersion contribution of the first isolator (7) and that of the second isolator (8) are substantially equalized.

### BACKGROUND OF THE INVENTION

Optical communications employing optical fibers as optical transmission lines are widespread. In the optical communication, distortion is caused in signal light by dispersion which is possessed by the optical fiber. Herein, a dispersion compensating module is used in order to suppress the signal distortion.

### SUMMARY OF THE INVENTION

The present invention provides a novel dispersion compensating module which is applied to optical communications etc. A dispersion compensating module according to the present invention comprises:

phase conjugate wave generation means for converting signal light into a phase conjugate wave so as to output the latter;

a signal light introducing passage which introduces the signal light into said phase conjugate wave generation means: and

a phase conjugate wave deriving passage which derives the phase conjugate wave outputted from said phase conjugate wave generation means;

wherein first retrocessive light restraint means for restraining any light from retroceding onto an input side of said signal light is disposed in said signal light introducing passage; and

second retrocessive light restraint means for restraining any light from retroceding onto a side of said phase conjugate wave generation means is disposed in said phase conjugate wave deriving passage.

### BRIEF DESCRIPTION OF THE DRAWINGS

Exemplary embodiments of the invention will now be described in conjunction with drawings in which:

FIG. 1 is an explanatory constructional view showing the first embodiment of a dispersion compensating module according to the present invention;

FIG. 2 is an explanatory constructional view showing the second embodiment of the dispersion compensating module according to the present invention;

FIG. 3 is an explanatory constructional view showing the third embodiment of the dispersion compensating module according to the present invention;

FIG. 4 is an explanatory diagram showing an example of construction of a phase conjugate wave generating device in the prior art; and

FIG. 5 is an explanatory diagram showing another example of a phase conjugate wave generating device in the prior art.

### DETAILED DESCRIPTION

As an example of a dispersion compensating module, an optical fiber module wherein a dispersion compensating optical fiber is coiled for modular implementation has been put into practical use. The dispersion compensating optical fiber which is applied to the optical fiber module, has a dispersion value which is opposite in sign to dispersion possessed by an optical fiber for optical transmission. This dispersion compensating optical fiber is set at a length at which dispersion cumulated in the transmission optical fiber (communication line) can be canceled.

The dispersion compensating module of this type is used in connection with, for example, the receiving side of the transmission optical fiber. Thus, the dispersion cumulated in the transmission optical fiber is canceled, and the pulse waveform of signal light is turned into a pulse waveform at the transmitting end of the transmission optical fiber. The dispersion compensating module is sometimes used in connection with the transmitting end of the transmission optical fiber, instead of the receiving side. In this mode of use, dispersion which is opposite in sign and equal in absolute value to a dispersion value predicted to be cumulated in the transmission optical fiber is afforded at the transmitting end by the dispersion compensating module, whereupon the signal light is transmitted.

Besides, as means for compensating the dispersion of light which propagates through an optical fiber, it has been proposed to compensate the dispersion by employing phase conjugate light. Papers which introduce the means are, for example, A. Yariv, D. Fekete and D. M. Pepper: “Compensation for channel dispersionbynonlinearopticalphaseconjugation”, OPTICS LETTERS/Vol. 4, No. 2/February 1979 (Paper #1), and S. Watanabe, S. Kaneko and T. Chikama: “Long-Haul Fiber Transmission Using Optical Phase Conjugation”, Optical Fiber Technology 2,169-178 1996 (Paper #2). Besides, examples of constructions of phase conjugate wave generating devices are disclosed in Japanese Patent Laid-Open No. 203914/1997, etc.

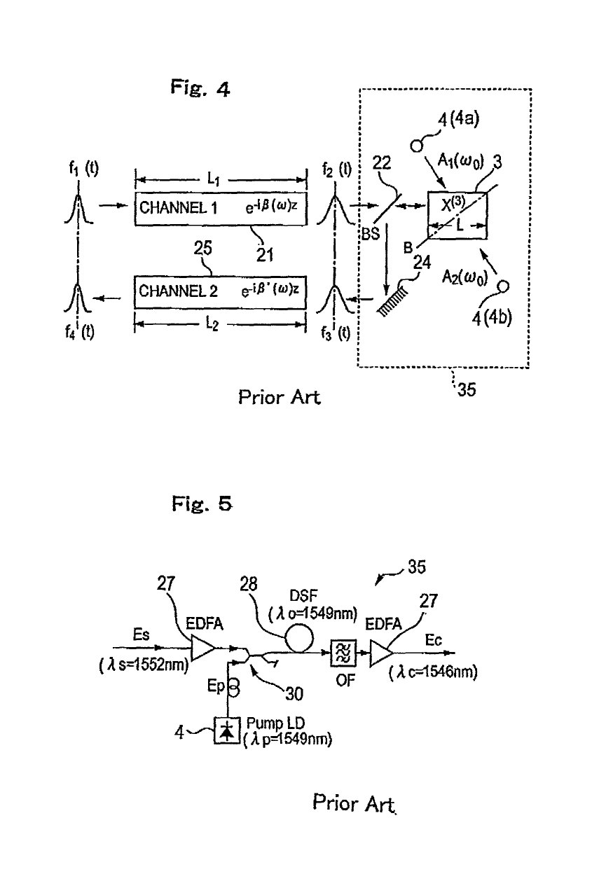

Shown in FIG. 4 is the construction of a phase conjugate wave generating device stated in Paper #1. The phase conjugate wave generating device 35 is constructed having a beam splitter (BS) 22, a nonlinear medium 3 and a mirror 24. Besides, pump laser diodes (pump LDs) 4(4a) and 4(4b) are disposed in opposition to the nonlinear medium 3. The pump laser diodes (pump LDs) 4 (4a) and 4 (4b) are arranged at positions which are in line symmetry with respect to the diagonal line B of the nonlinear medium 3.

In the proposed example of FIG. 4, the output end of an input optical fiber 21 is optically coupled with the entrance side of the beam splitter 22, so that light having propagated through the input optical fiber 21 enters the beam splitter 22. The light having passed through the beam splitter 22 enters the nonlinear medium 3 to be converted into a phase conjugate wave. The phase conjugate wave exits from the nonlinear medium 3 into the reverse direction (into a direction in which it retrogresses along the path of the entrance). Subsequently, the phase conjugate wave is reflected by the beam splitter 22 and the mirror 24 to enter an output optical fiber 25, through which it is outputted.

The nonlinear medium 3 is pumped by pumping lights caused to enter the nonlinear medium 3 at angles at which the phase conjugate wave is to be generated. As a result, the phase conjugate wave is generated by the well-known phenomenon which is induced by the third-order nonlinear susceptibility χ⁽³⁾, In FIG. 4, the pumping lights are the pumping light A₁ (angular frequency 107 ₀) of the pump laser diode 4(4a), and the pumping light A2 (angular frequency ω_{D}) of the pump laser diode 4 (4b).

In the construction shown in FIG. 4, a light pulse f₁(t) entered from the input side (light transmitting side) of the input optical fiber 21 undergoes distortion during its propagation through this input optical fiber 21, and it becomes a light pulse f₂(t) at the output end of the input optical fiber 21. The light pulse f₂(t) is passed through the beam splitter 22. Thereafter, it is passed through the nonlinear medium 3 and is converted into the phase conjugate wave. The phase conjugate wave of the light pulse f₂(t) is a wave obtained by time-inverting this light pulse f₂(t), so that when the phase conjugate light retrocedes into the input optical fiber 21 again, its waveform becomes quite the same as the waveform of the light pulse f₁(t).

However, no optical communication can be performed when the phase conjugate wave retrocedes into the input optical fiber 21. In the proposed example of FIG. 4, therefore, the phase conjugate wave is led onto the side of the output optical fiber 25 by the beam splitter 22 and the mirror 24. Further, a light pulse f₄(t) having quite the same waveform as that of the light pulse f₁(t) can be outputted from the output optical fiber 25 in such a way that the optical fibers 21, 25 are formed so as to satisfy the following equation (1):

$$\frac{{\partial }^{2} β}{\partial {ω}^{2}} {L}_{1} = \frac{{\partial }^{2} {β}^{′}}{\partial {ω}^{2}} {L}_{2} \qquad ( 1 )$$

In Equation (1), β denotes the propagation constant of the optical fiber 21, β′ the propagation constant of the optical fiber 25, ω the angular frequency of the lights propagating through the optical fibers, L₁ the length of the input optical fiber 21, and L₂ the length of the output optical fiber 25. In actuality, dispersion ascribable to the beam splitter 22 and the mirror 24 is involved, but it is slight compared with dispersion in the transmission optical fiber (the input optical fiber 21 and the output optical fiber 25 in FIG. 4). Accordingly, the dispersion ascribable to the beam splitter 22 and the mirror 24 is negligible, and the waveform of the light pulse f₁(t) and that of the light pulse f₄(t) can be regarded as being the same.

On the other hand, a device 35 proposed in Paper #2 is constructed having erbium-doped fiber amplifiers (EDFAs) 27, a dispersion shifted fiber (DSF) 28, a pump laser diode 4 and a coupler 30 as shown in FIG. 5. This device 35 generates a phase conjugate wave by utilizing nondegenerate four-wave mixing which occurs in the dispersion shifted fiber 28.

The dispersion value of each optical fiber for an optical transmission line differs variously in accordance with the length thereof. Therefore, in a case where an optical fiber module employing a dispersion compensating optical fiber is applied as a dispersion compensating module, it is necessary to obtain the dispersion values of the respective optical fibers constituting the optical transmission line and to investigate the total dispersion value of the optical transmission line beforehand. An optical transmission line management is necessitated therefor. That is, the dispersion compensating optical fiber which has a dispersion value capable of compensating the total dispersion value needs to be applied every optical transmission line. Accordingly, the design of the optical fiber module is not easy.

Besides, the device shown in FIG. 4 is not provided with means for restraining the light from retroceding onto the light transmitting side. Therefore, in a case where the phase conjugate wave generating device 35 is applied to an optical communication system, the phase conjugate wave generated by this device 35 retrocedes onto the signal light transmitting side and makes the optical communication system unstable, For this reason, it is difficult to put the device shown in FIG. 4, into practical use as the dispersion compensating module.

In particular, a dense wavelength division multiplexing (DWDM) transmission system wherein 32 or 48 lights of wavelengths differing from one another are multiplexed and transmitted at a high density has been put into practical use at present. It is also considered to multiplex and transmit 100 or more lights at a superhigh density in a wavelength division multiplexing system in the future. When the phase conjugate wave generating device 35 in Paper #1 is applied to such a system, a nonlinear phenomenon is induced under the influence of retrocessive lights. More specifically, granted that the light of one wavelength has low power, the power density of the lights of all the wavelengths heightens within the optical fiber as the multiplexing degree of the wavelengths increases, so that the nonlinear phenomenon is induced under the influence of the retrocessive lights of the high power density.

Then, although the wavelength distortion ascribable to the dispersion of the light transmitting optical fiber can be suppressed by the phase conjugate wave generating device 35, a wavelength distortion ascribable to the above nonlinear phenomenon appears. The system becomes unstable to make the realization of the wavelength division multiplexing (WDM) impossible. It is therefore difficult to apply the apparatus of FIG. 4 to the WDM transmission system.

Further, the phase conjugate wave generating device 35 of FIG. 4 requires the alignment of the optic axes of the laser beams entered from the two pump laser diodes 4(4a), 4(4b), the adjustment of the angle of incidence of the incident light on the nonlinear medium 3, the high-precision adjustments of the optic axes of the beam splitter 22, mirror 24 and output optical fiber 25 for efficiently introducing the phase conjugate wave into the output optical fiber 25, and so forth. Such a considerable number of operations of the high-precision adjustments of the optic axes are difficult to make the fabrication of the device laborious. This incurs the problem that the available percentage of fabricated articles is inferior.

On the other hand, the phase conjugate wave generating device 35 shown in FIG. 5 includes the dispersion shifted fiber 28. In a case where the dispersion shifted fiber 28 is wound round a bobbin or the like for the modular implementation, the radius of the winding needs to be as large as, at least, several tens mm. It is therefore difficult to reduce the size of the device.

Another problem is that, on account of the construction in which the phase conjugate wave is generated by the nondegenerate four-wave mixing, a transmitted light signal has its wavelength changed by the conversion into the phase conjugate wave.

More specifically, in a case where the DSF 28 is pumped at the same wavelength as that of the signal light, this signal light undergoes the optical Kerr effect within the DSF 28. Thus, the refractive index of the DSF 28 is changed depending upon the optical intensity of the light pulse, thereby to form a cause for distorting the light pulse still further. It is therefore difficult to generate the phase conjugate wave at the same wavelength as that of the input signal light by the nondegenerate four-wave mixing. As stated above, accordingly, the wavelength of the phase conjugate wave becomes different from that of the input signal light.

In a case where the wavelength of the input signal light is different from that of the phase conjugate wave in this manner, the signal light undergoes different distortions due to the difference of the wavelengths in an optical fiber line immediately preceding the device and an optical fiber line immediately succeeding the device even if these optical fiber lines are quite the same. It is necessitated for compensating the difference of the distortions to grasp the dispersion of the optical transmission line beforehand and to adjust the length thereof.

Moreover, in the case where the wavelengths of the signal light and the phase conjugate wave are different, the distortion differs every signal light wavelength. Accordingly, in the case where the phase conjugate wave generating device 35 of FIG. 5 is applied to the WDM transmission, the optical transmission line needs to be managed by grasping the dispersion values thereof at the respective wavelengths of signal lights, and hence, the line management becomes complicated.

Assuming that the phase conjugate wave at the same wavelength as the signal light wavelength be generated by the degenerate four-wave mixing, it is very difficult to convert 100% of the signal light into the phase conjugate wave. In the phase conjugate wave generating device 35 shown in FIG. 5, the signal light and the phase conjugate wave proceed in an identical direction. It is therefore impossible to separate the generated phase conjugate wave and the distorted signal. In consequence, a superposed signal which consists of the distorted signal light and the phase conjugate wave is transmitted from the phase conjugate wave generating device 3 5.

In one aspect thereof, the present invention provides a dispersion compensating module which is easy of fabrication, and which is so suited to, for example, wavelength division multiplexing (WDM) transmission that, when applied to an optical communication system of the WDM transmission, the dispersion compensating module does not incur wavelength distortions ascribable to the dispersion, nonlinear phenomenon etc. of an optical transmission line.

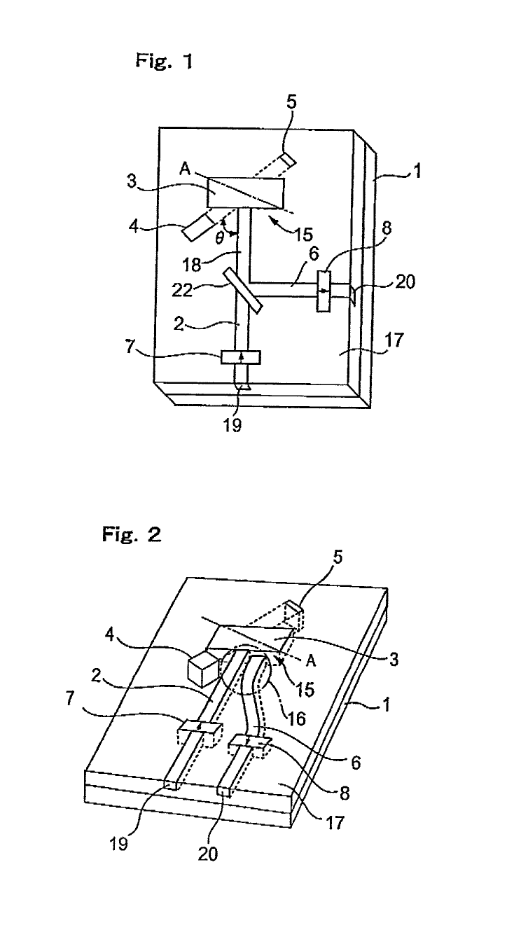

Shown in FIG. 1 is the construction of the first embodiment of a dispersion compensating module according to the present invention.

As shown in the figure, a waveguide forming region 17 is formed on the upper surface side of a silicon substrate 1 by way of example. An optical waveguide circuit in the shape of letter T is formed in the waveguide forming region 17. The optical waveguide circuit includes a light input waveguide 2 being a signal light introducing passage, a light output waveguide 6 being a phase conjugate wave deriving passage, and a light input/output waveguide 18. The light input/output waveguide 18 plays both the role of a signal light introducing passage and the role of a phase conjugate wave deriving passage A beam splitter 22 is disposed aslant at the boundary part between the light input/output waveguide 18 and the light input waveguide 2.

In the illustrated example, phase conjugate wave generation means 15 for converting signal light into a phase conjugate wave so as to output the latter is disposed in the waveguide forming region 17. The phase conjugate wave generation means 15 includes a nonlinear medium 3, a pump laser diode 4 which is means for emitting pumping light for pumping the nonlinear medium 3, and a mirror 5 which reflects the pumping light. By way of example, the pumping light reflection mirror 5 and the pump laser diode 4 are arranged at positions which are in line symmetry with respect to the diagonal line A of the nonlinear medium 3. The pumping light reflection mirror 5 functions as reflection means for reflecting the pumping light emitted from the pump laser diode 4 and passed through the nonlinear medium 3, onto the side of this nonlinear medium 3.

In this embodiment, signal light introduction means for introducing the signal light into the phase conjugate wave generation means 15 is constructed having the light input waveguide 2, beam splitter 22 and light input/output waveguide 18. In the going path of the signal light toward the nonlinear medium 3, the light input waveguide 2 and the light input/output waveguide 18 form a signal light introducing passage (a passage for waveguiding the signal light) The signal light inputted from a light input portion 19 propagates through the light input waveguide 2 and enters the beam splitter 22. The signal light having passed through the beam splitter 22 propagates through the light input/output waveguide 18 upwards as viewed in the drawing. Then, the signal light enters the nonlinear medium 3 of the phase conjugate wave generation means 15.

Besides, in this embodiment, phase conjugate wave derivation means for deriving the phase conjugate wave outputted from the phase conjugate wave generation means 15, onto the light output side of the dispersion compensating module, is formed on the substrate 1. In the example shown here, the phase conjugate wave derivation means is constructed having the light input/output waveguide 18, beam splitter 22 and light output waveguide 6. In a path along which the phase conjugate wave generated by the nonlinear medium 3 proceeds toward a light output portion 20, the light input/output waveguide 18 and the light output waveguide 6 form a phase conjugate wave deriving passage (a passage for waveguiding the phase conjugate wave). The phase conjugate wave generated by the phase conjugate wave generation means 15 propagates through the light input/output waveguide 18 downwards as viewed in the drawing, and it is thereafter reflected by the beam splitter 22 to enter the light output waveguide 6. Then, the phase conjugate wave propagates through the light output waveguide 6 and is outputted from the light output portion 20.

In one embodiment here, the light input waveguide 2 which forms the passage for waveguiding the signal light is provided with a first isolator 7 which is first retrocessive light restraint means for restraining any light from retroceding onto the input side of the signal light. Further, the light output waveguide 6 which forms the passage for waveguiding the phase conjugate wave is provided with a second isolator 8 which is second retrocessive light restraint means for restraining any light from retroceding onto the side of the phase conjugate wave generation means 15.

In one embodiment here, the dispersion contribution of the first isolator 7 and that of the second isolator 8 are substantially equalized. Besides, in the illustrated example, the constituents such as the phase conjugate wave generation means, the first and second retrocessive light restraint means and the beam splitter 22, and the waveguides 2, 6 and 18, which constitute the dispersion compensating module, are integrated and formed on the semiconductor substrate (silicon substrate 1 here). Thus, the dispersion compensating module is constructed as a single-chip component.

In an example, in order to prevent the system from becoming unstable due to the reflected retrocessive light, the first and second isolators 7, 8 having isolation characteristics of at least 40 dB are applied.

Assuming by way of example that the generation intensity of the phase conjugate wave at one wavelength be 0 dBm, and that the isolation of the beam splitter 22 be 40 dB, the retrocessive light of the phase conjugate wave retrocedes at about −40 dBm from the beam splitter 22 and enters the light input waveguide 2. On this occasion, the isolation of 40 dB is afforded by the first isolator 7, whereby the retrocessive light of the phase conjugate wave retroceding onto the side of the light input portion 19 (that is the signal light input side) is reduced down to −80 dBm or below.

Moreover, the second isolator 8 is disposed on the side of the light output waveguide 6, whereby the light reflected by the beam splitter 22 is restrained from retroceding onto the side of this beam splitter 22 when it passes through the light output waveguide 6.

By way of example, in a wavelength division multiplexing (WDM) system in which lights of 100 wavelengths are multiplexed, one dispersion compensating module of this embodiment is applied to each of lights demultiplexed from the multiplexed lights Assuming that any of respective retrocessive lights corresponding to the 100 waves be quite the same in the above case, the intensity of all the reflected retrocessive lights heightens 100 times, and the whole intensity increases 20 dB. Even in this case, the intensity of all the reflected retrocessive lights becomes −80+20=−60 (dBm) and this is a small value at which the retrocessive lights do not form a cause for inducing a nonlinear effect.

The induction of the nonlinear effect attributed to the reflected retrocessive light intensity depends upon the WDM system to which the dispersion compensating module is applied. In general, a return loss in an optical connector used in the WDM system is −35 dB or below. Since any problem has never been posed in the WDM system by reflected light from the optical connector (by the return loss of the optical connector), the above retrocessive lights of −60 dBm are not problematic at all.

Besides, in this embodiment, the nonlinear medium 3 is formed of Fe:LiNbO₃ (iron-doped lithium niobate). Herein, in order to efficiently generate the phase conjugate wave by the nonlinear medium 3, the angle (phase matching angle) θ between the light input waveguide 2 and the pump laser diode 4 is set at 45 degrees. The lasing wavelength of the pump laser diode 4 is the same as the wavelength of the signal light, and it is, for example, 1552 nm.

Here, degenerate four-wave mixing will be explained. First, in a case where three light waves are inputted to the nonlinear medium 3, nonlinear polarization P(NL) is induced by the third-order nonlinear susceptibility χ⁽³⁾. The angular frequencies of the three light waves are denoted by ω1, ω2 and ω3, and the propagation constants thereof by k1, k2 and k3 (which are vector quantities each having a direction), respectively. In generating a phase conjugate wave by the degenerate four-wave mixing, light waves at an identical wavelength are inputted to the nonlinear medium, so that ω1=ω2=ω3 holds. For the brevity of the explanation, the value of ω1=ω2=ω3 is put to ω0.

Letting ω4 denote the angular frequency of the light wave which is generated by the nonlinear polarization P(NL) based on the three light waves, ω4=ω1+ω2−ω3=ω0 holds in accordance with the law of energy conservation. That is, the angular frequency of the generated light wave is ω0, and all the wavelengths of the phase conjugate wave, the signal light and the pumping light become equal.

Regarding the propagation constant of the generated light wave, letting k4 denote this propagation constant which is generated by the nonlinear polarization P(NL) based on the three light waves, k4=k1+k2−k3 needs to be satisfied in accordance with the law of energy conservation. Here, when k1 and k2 are considered as the propagation constants of the pumping lights opposed to each other, k1=−k2 holds, and hence, k4=−k3 holds. Accordingly, the generated phase conjugate wave is in the direction of −k3, that is, it retrogresses relative to the input light.

The nonlinear medium for attaining the effect of the generation of the phase conjugate wave as stated above is ordinarily an anisotropic crystal. In general, the angle of incidence of the pumping light on the nonlinear medium, the angle of incidence of the signal light on the nonlinear medium, and the angle of exit of the phase conjugate wave from the nonlinear medium must be specified values, respectively. The reason therefor is that the nonlinear susceptibility χ⁽³⁾ of the nonlinear medium is a tensor, so the magnitude of the phase conjugate wave differs depending upon the correlation (the phase matching angle mentioned before) between the angle of incidence of the pumping light on the nonlinear medium and the angle of incidence of the signal light on the nonlinear medium.

The nonlinear medium 3 applied to the embodiment is Fe:LiNbO₃. In this case, the phase conjugate wave based on the degenerate four-wave mixing can be efficiently generated by setting the angle θ between the light input waveguide 2 and the pump laser diode 4 at 45 degrees.

When the dispersion compensating module of the embodiment described above is to be fabricated, silica-based glass is deposited and formed on a silicon substrate 1, thereby to form a waveguide forming region 17 which includes an optical waveguide circuit. Further, grooves for inserting first and second isolators 7, 8 and a beam splitter 22 are formed so as to traverse the optical waveguide circuit of the waveguide forming region 17. Subsequently, the first and second isolators 7, 8 and the beam splitter 22 are respectively inserted into the insertion grooves.

Thereafter, a nonlinear medium 3 is disposed in opposition to the end face of the light input/output waveguide 18 of the optical waveguide circuit. Further, a pump laser diode 4 and a pumping light reflection mirror 5 are respectively disposed at symmetric positions with respect to the diagonal line A of the nonlinear medium 3. Then, the dispersion compensating module is finished up.

One embodiment of the present invention is constructed and fabricated as thus far described. The light input waveguide 2 is provided with the first isolator 7 which restrains any light from retroceding onto the input side of the signal light. Thus, the phase conjugate wave generated by the phase conjugate wave generation means 15 is reliably restrained from retroceding onto the signal light generating side. Besides, the light output waveguide 6 is provided with the second isolator 8 which restrains any light from retroceding onto the side of the phase conjugate wave generation means 15. Thus, the phase conjugate wave generated by the phase conjugate wave generation means 15 is reliably restrained from retroceding onto the side of this phase conjugate wave generation means 15.

Moreover, in the foregoing example, the isolations of the first and second isolators 7, 8 are set at, at least, 40 dB. Thus, the appearance of the signal light distortion ascribable to the nonlinear phenomenon can be reliably suppressed using the dispersion compensating module of this embodiment in a wavelength division multiplexing system in which the number of multiplexed wavelengths is large (for example, it is 100). The reason therefor is that, even in a case where the dispersion compensating modules of this embodiment are applied to respective lights demultiplexed from the lights of the multiplexed wavelengths one by one, the intensity of all reflected retrocessive lights can be made a small value which does not form a cause for inducing a nonlinear effect.

In addition, according to one embodiment, the dispersion contribution of the first isolator 7 and that of the second isolator 8 are substantially equalized. Therefore, the influence of the dispersion (chromatic dispersion) which the signal light undergoes when passing through the first isolator 7 can be canceled by the dispersion (chromatic dispersion) which the phase conjugate wave undergoes when passing through the second isolator 8.

Accordingly, distortions ascribable to the chromatic dispersions (occurring in the isolators) are not increased by disposing the first and second isolators 7, 8 as in this embodiment. According to one embodiment mentioned above, the dispersion compensating module is so excellent that it compensates distortion ascribable to the chromatic dispersion of a transmission optical fiber and that it does not incur the occurrence of distortion ascribable to the nonlinear phenomenon of the transmission optical fiber.

Further, since the means (constituents) constituting the dispersion compensating module are integrated and formed on the silicon substrate 1, the alignment of the optic axes of the constituents is very easy. Therefore, the articles of the module can be manufactured at a high precision, with ease, and at a good available percentage. Besides, the module can be made very small in size.

Still further, the phase conjugate wave generation means 15 is constructed by disposing the single pump laser diode 4 and the pumping light reflection mirror 5, unlike the construction of the phase conjugate wave generating device 35 in Paper #1 mentioned before (in FIG. 4) wherein the two pump laser diodes 4a, 4b are disposed. When the reflecting function of the pumping light reflection mirror 5 is utilized in this manner, the generation of the phase conjugate wave by the nonlinear medium 3 can be done very efficiently. In addition, the alignment of the optic axes of the pump laser diode 4 and the pumping light reflection mirror 5 is facilitated still more.

Shown in FIG. 2 is the second embodiment of the dispersion compensating module according to the present invention. The second embodiment is constructed to be substantially similar to the first embodiment. The points of difference of the second embodiment from the first embodiment are that the light input/output waveguide 18 (refer to FIG. 1) and the beam splitter 22 (refer to FIG. 1) are omitted, and that the exit end side of a light input waveguide 2 and the entrance end side of a light output waveguide 6 are held close to each other, thereby to form a directional coupler 16.

As is well known, the directional coupler 16 has an optical branching function. In the second embodiment, accordingly, signal light entered from the light input waveguide 2 enters a nonlinear medium 3 through the directional coupler 16. Besides, a phase conjugate wave generated by the nonlinear medium 3 enters the light output waveguide 6 through the directional coupler 16.

In the second embodiment, signal light introduction means is constructed having the light input waveguide 2 and the directional coupler 16. Besides, phase conjugate wave derivation means is constructed having the light output waveguide 6 and the directional coupler 16.

Besides, in the second embodiment, the isolation of the directional coupler 16 is set at 40 dB by way of example.

Also the second embodiment can bring forth effects similar to those of the first embodiment by similar operations.

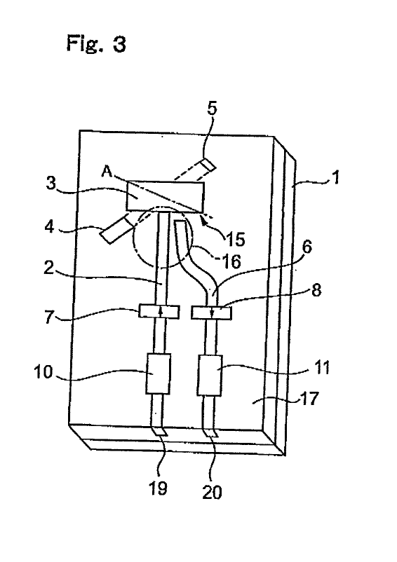

Shown in FIG. 3 is the third embodiment of the dispersion compensating module according to the present invention. The third embodiment is constructed to be substantially similar to the second embodiment. The point of difference of the third embodiment from the second embodiment is that optical semiconductor amplifiers 10, 11 being optical amplification means are respectively interposed in a light input waveguide 2 and a light output waveguide 6. The dispersions of the optical semiconductor amplifiers 10, 11 are substantially equalized to each other.

Also the third embodiment can bring forth effects similar to those of the first and second embodiments by similar operations.

Besides, according to the third embodiment, the optical semiconductor amplifiers 10, 11 are integrated on a substrate 1, so that optical amplification functions can be achieved within the dispersion compensating module. That is, the dispersion compensating module of the third embodiment can simultaneously achieve both the dispersion compensation and the optical amplification. Accordingly, when the dispersion compensating module of the third embodiment is applied for the dispersion compensation of, for example, a wavelength division multiplexing (WDM) transmission system, the optical semiconductor amplifiers 10, 11 disposed in the dispersion compensating module can be substituted for repeating optical amplifiers disposed in the relay station of the system at present. Thus, the system can be simplified.

The dispersion compensating module according to the present invention is employed for, for example, WDM transmission. When a phase conjugate wave retrocedes onto the generation side of signal light, an optical communication system becomes unstable due to the retrocessive light, and particularly when the degree of wavelength multiplexing in the system is increased, a nonlinear phenomenon is induced by the retrocessive light. In the present intention, however, the phase conjugate wave can be reliably restrained from retroceding onto the signal light generating side as stated before, and hence, the occurrence of signal light distortion ascribable to the nonlinear phenomenon can be reliably suppressed.

The dispersion compensating module in each of the embodiments of the present invention is an excellent one which compensates distortion ascribable to the chromatic dispersion of a transmission optical fiber, and which does not incur the occurrence of distortion ascribable to the nonlinear phenomenon of the transmission optical fiber. Optical fiber cables which are disposed for dispersion compensation at present and whose various parameters are different, are dispensed with by applying the dispersion compensating module of the embodiment to optical communications such as WDM transmission Therefore, an optical transmission line can be built of optical fiber cables of one sort having the same parameters, so that optical transmission line management can be simplified.

The present invention is not restricted to the foregoing embodiments, but it can adopt various aspects of performance. By way of example, although Fe:LiNbO₃ is employed as the nonlinear medium 3 in the embodiments, the nonlinear medium 3 may be any nonlinear medium capable of generating a phase conjugate wave. A thin film of barium titanate (BaTiO₃) or semiconductor multiple quantum well (MQW) structure, for example, is applicable as the nonlinear medium 3.

In addition, although the light input waveguide 2 and the light output waveguide 6 are respectively formed up to the end parts 19, 20 of the substrate 1 in each of the embodiments, they may well be formed up to the intermediate parts of the substrate 1 in the lengthwise direction thereof. In this case, it is also possible to employ a construction in which V-grooves communicating with the respective waveguides 2, 6 are formed on the substrate 1, and in which optical fibers are inserted and fixed in the V-grooves and are connected with the corresponding waveguides 2, 6.

Yet in addition, although the phase conjugate wave generation means 15 is constructed by disposing the nonlinear medium 3, pump laser diode 4 and pumping light reflection mirror 5 in each of the embodiments, it may well be constructed by disposing the nonlinear medium 3, and two pump laser diodes 4 which are arranged in opposition to each other and which cause pumping lights to enter the nonlinear medium 3.

Further, although the optical semiconductor amplifiers 10, 11 being optical amplification means are respectively interposed in the light input waveguide 2 and the light output waveguide 6 in the third embodiment, optical amplification means different from the optical semiconductor amplifiers 10, 11 may well be interposed in the light input waveguide 2 and the light output waveguide 6.

What is claimed is:

1. A dispersion compensating module comprising:
phase conjugate wave generation means for converting signal light into a phase conjugate wave so as to output the latter;
a signal light introducing passage which introduces the signal light into said phase conjugate wave generation means; and
a phase conjugate wave deriving passage which derives the phase conjugate wave outputted from said phase conjugate wave generation means;
wherein first retrocessive light restraint means for restraining any light from retroceding onto an input side of said signal light is disposed in said signal light introducing passage; and
second retrocessive light restraint means for restraining any light from retroceding onto a side of said phase conjugate wave generation means is disposed in said phase conjugate wave deriving passage.

2. A dispersion compensating module according to claim 1, wherein dispersion contribution of said first retrocessive light restraint means and that of said second retrocessive light restraint means are substantially equalized.

3. A dispersion compensating module according to Claim 2, wherein optical amplification means are respectively disposed in said signal light introducing passage and said phase conjugate wave deriving passage.

4. A dispersion compensating module according to claim 3, wherein a dispersion value of said optical amplification means disposed in said signal light introducing passage and that of said optical amplification means disposed in said phase conjugate wave deriving passage are substantially equalized.

5. A dispersion compensating module according to claim 1, wherein:
said phase conjugate wave deriving passage is branched from and connected with an intermediate part of said signal light introducing passage;
a beam splitter which transmits said signal light to said phase conjugate wave generation means and which guides said phase conjugate wave from said phase conjugate wave generation means to said phase conjugate wave deriving passage, is disposed at the branch connection part; and
a part of said signal light introducing passage between said beam splitter and said phase conjugate wave generation means functions also as said phase conjugate wave deriving passage which guides said phase conjugate wave from said phase conjugate wave generation means to said beam splitter.

6. A dispersion compensating module according to claim 1, wherein an exit end part of said signal light introducing passage optically coupled to said phase conjugate wave generation means and an entrance end part of said phase conjugate wave deriving passage are arranged close to each other, thereby to form a directional coupler.

7. A dispersion compensating module according to claim 1, wherein said phase conjugate wave generation means comprises:
a nonlinear medium;
emission means for emitting pumping light for pumping said nonlinear medium; and
reflection means for reflecting the pumping light emitted from the pumping light emission means and passed through said nonlinear medium, onto a side of said nonlinear medium.

8. A dispersion compensating module according to claim 1, wherein said phase conjugate wave generation means comprises:
a nonlinear medium; and
pumping light emission means arranged in opposition to each other with said nonlinear medium interposed therebetween, and for pumping said nonlinear medium from both sides thereof.

9. A dispersion compensating module according to claim 7, wherein said nonlinear medium generates said phase conjugate wave on the basis of degenerate four-wave mixing.

10. A dispersion compensating module according to claim 8, wherein said nonlinear medium generates said phase conjugate wave on the basis of degenerate four-wave mixing. 11. A dispersion compensating module according to claim 1, wherein:
said light introducing passage and said phase conjugate wave deriving passage are formed on a semiconductor substrate; and
at least one of said phase conjugate wave generation means, said first retrocessive light restraint means and said second retrocessive light restraint means is integrated and formed on said semiconductor substrate.
